(19) United States
(12) Patent Application Publication
(10) Pub. No.: US 2018/0174210 A1
(43) Pub. Date: Jun. 21, 2018

(54) SYSTEMS AND METHODS FOR DETECTING DATA INCONSISTENCIES

(71) Applicant: MasterCard International Incorporated, Purchase, NY (US)

(72) Inventors: Kyle Williams, O'Fallon, MO (US); David J. Senci, Troy, IL (US); Michelle L. Hafner, Chesterfield, MO (US)

(21) Appl. No.: 15/380,594

(22) Filed: Dec. 15, 2016

(51) Int. Cl. G06Q 30/04; G06Q 30/00; G06Q 20/40

(52) U.S. Cl. CPC G06Q 30/04; G06Q 20/401; G06Q 30/0185

(57) ABSTRACT

An enhanced automatic billing updater (ABU) computing device for detecting data inconsistencies thereby reducing fraudulent transactions or identifying data integrity issues is described. The ABU computing device is configured to store account data in an ABU account information database including a plurality of account identifiers of closed accounts, receive an authorization request message including a candidate account identifier, the authorization request message requesting authorization of a transaction, and compare the candidate account identifier with the plurality of account identifiers associated with closed accounts stored in the ABU account information database. The ABU computing device is further configured to identify an account identifier associated with a closed account stored in the ABU account information database matching the candidate account identifier, generate a notification message indicating that the candidate account is closed, and transmit the notification message to at least one party associated with the authorization request message.

### BACKGROUND

The field of the disclosure relates generally to tracking data inconsistencies and, more particularly, to network-based systems and methods for monitoring data inconsistencies in accounts to identify potential fraudulent activity and data integrity issues.

The same data may be stored in multiple locations within a computer network. For example, data may be stored in a first location within a network while the same data is also stored in another (second) location. In some cases, data stored in the first location may become outdated or stale when the same data is updated at the second location. In at least some of these cases, it is important to update the data stored in the first location with the updated data that is stored at the second location. However, there are many challenges associated with updating such stale data especially when the stale data may be stored in multiple locations, and in ensuring that the actual updates have occurred.

For example, in the payment card industry at least some payment transactions are performed where the cardholder makes a purchase, but the physical payment card is not present for the merchant to inspect when the purchase is made. These transactions are known as “card-not-present” (CNP) transactions. In such transactions, information regarding the payment card, including an account number and, in many instances, an expiration date for the payment card is transmitted from a merchant, along with an indicator that the transaction is a CNP transaction. An “account-on-file” transaction is a type of transaction in which the merchant stores information regarding the cardholder's payment card in a database, then retrieves the stored payment card information and includes it in an authorization request message submitted when processing the transaction. One specific type of account-on-file transaction is a “recurring payment transaction,” which a merchant initiates on a recurring basis for a particular cardholder. In such recurring payment transactions, the merchant stores information regarding the cardholder's payment card in a database, then retrieves the stored payment card information and includes it in each recurring authorization request message.

An example is a gym membership. Rather than mailing a monthly check for membership with a gym, a cardholder might choose to register a payment card, such as a credit card, a debit card, or a prepaid card, with the gym. Registering the payment card with the gym enables the gym to automatically charge the payment card for the monthly dues on a particular day each month. In some such systems, the merchant stores an account number, an expiration date, and/or other information associated with the payment card and/or cardholder. Given the convenience of this payment model for both merchants and cardholders, it finds use in many other scenarios where a cardholder is a member of a club or subscriber of products or services. Accordingly, multiple merchants may have stored payment card information for the same cardholder. Likewise, any given merchant may have stored payment card information for multiple cardholders.

In addition to recurring payment transactions, merchants may also maintain account-on-file information to facilitate payment card transactions by repeat customers. For example, an online merchant may allow a shopper to create an online account and store account data corresponding to one or more methods of payment. When the shopper is ready to check out and complete a purchase, the shopper may simply select one of the stored payment methods as opposed to having to re-enter their payment card information.

A downside of storing payment card information, however, is that information regarding a payment card is subject to change. For example a cardholder's payment card might expire, causing a new payment card to be issued with a new expiration date while the card number remains the same. In such instances, an authorization request message containing the outdated expiration date is denied by the issuer of the payment card. As a result, the merchant that originally submitted the authorization request is prevented from successfully obtaining payment until the merchant acquires the updated expiration date for the payment card. Due to wide adoption of the account-on-file payment model by merchants and cardholders, it is understandably difficult for a cardholder to update each merchant with new payment card expiration dates. Likewise, it reduces the benefits of the account-on-file payment model to require a merchant to inquire with each cardholder for an updated payment card expiration date prior to submitting each payment authorization request.

In light of the foregoing, at least some known systems may provide merchants with updated cardholder payment card information. However, to obtain the updated account data in such systems, a merchant must submit an account query corresponding to one or more payment card accounts to the merchant's acquiring bank which then forwards the query to a central account data system. In response to the query, the account data system retrieves corresponding account data received from an issuer and transmits the retrieved account data to the acquiring bank. The acquiring bank may then forward the retrieved account data to the merchant, which may then update its database of account-on-file payment card information.

These known systems are limited in several ways. For example, these known systems do not guarantee that a merchant will actually update its account-on-file account data or do so in a timely manner. Furthermore, these known systems do not monitor closed accounts that may continue to be used to initiate payment transactions, either as a result of fraudulent activity or due to data integrity issues. In light of the foregoing, an enhanced account data system is needed, wherein the enhanced systems and methods address these problems and others.

### BRIEF DESCRIPTION

In one aspect, an automatic billing updater (ABU) computing device for detecting data inconsistencies thereby reducing fraudulent transactions or identifying data integrity issues is disclosed. The ABU computing device includes one or more processors in communication with one or more memory devices. The ABU computing device is configured to store account data in an ABU account information database including a plurality of account identifiers of closed accounts, and receive an authorization request message including a candidate account identifier, the authorization request message requesting authorization of a transaction. The ABU computing device is also configured to compare the candidate account identifier with the plurality of account identifiers associated with closed accounts stored in the ABU account information database, and identify an account identifier associated with a closed account stored in the ABU account information database matching the candidate account identifier. The ABU computing device is further configured to generate a notification message indicating that the candidate account is closed, and transmit the notification message to at least one party associated with the authorization request message.

In a second aspect, a computer-implemented method for detecting data inconsistencies thereby reducing fraudulent transactions or identifying data integrity issues is provided. The method is implemented using an automatic billing updater (ABU) computing device. The method includes storing account data in an ABU account information database including a plurality of account identifiers of closed accounts, and receiving an authorization request message including a candidate account identifier, the authorization request message requesting authorization of a transaction. The method also includes comparing the candidate account identifier with the plurality of account identifiers associated with closed accounts stored in the ABU account information database, and identifying an account identifier associated with a closed account stored in the ABU account information database matching the candidate account identifier. The method still further includes generating a notification message indicating that the candidate account is closed, and transmitting the notification message to at least one party associated with the authorization request message.

In yet another aspect, a non-transitory computer-readable storage medium having computer-executable instructions embodied thereon. When executed by an automatic billing updater (ABU) computing device including a processor in communication with a memory, the computer-executable instructions cause the ABU computing device to store account data in an ABU account information database including a plurality of account identifiers of closed accounts, and receive an authorization request message including a candidate account identifier, the authorization request message requesting authorization of a transaction. The computer-executable instructions also cause the ABU computing device to compare the candidate account identifier with the plurality of account identifiers associated with closed accounts stored in the ABU account information database, and identify an account identifier associated with a closed account stored in the ABU account information database matching the candidate account identifier. The computer-executable instructions further cause the ABU computing device to generate a notification message indicating that the candidate account is closed, and transmit the notification message to at least one party associated with the authorization request message.

### BRIEF DESCRIPTION OF THE DRAWINGS

FIGS. 1-4 show example embodiments of the methods and systems described herein.

FIG. 1 is a schematic diagram illustrating a payment processing system including an enhanced automatic billing updater (ABU) computing device for monitoring payment authorizations associated with closed payment card accounts.

FIG. 2 is a diagram illustrating an ABU manager system including the enhanced ABU computing device shown in FIG. 1, in communication with the payment processing system of FIG. 1.

FIG. 3 is a diagram illustrating an example of the enhanced ABU computing device shown in FIGS. 1 and 2.

FIG. 4 is a flow chart illustrating an example method for monitoring potential fraudulent activity and data integrity issues using the enhanced ABU computing device shown in FIGS. 1 and 2 in accordance with one example embodiment of the present disclosure.

### DETAILED DESCRIPTION

The systems and methods described herein are directed to an enhanced automatic billing updater (ABU) computing device (referred to herein as an “ABU computing device”) for monitoring payment authorizations associated with closed payment card accounts, and for providing corresponding feedback and data to corresponding issuers. The ABU computing device includes at least one processor and a memory. The ABU computing device stores data associated with closed accounts in the memory. When the ABU computing device receives an authorization request message (e.g., an ISO 8583 computer network message) associated with a payment transaction that includes an identifier of a closed account, the ABU computing device generates a notification message that is transmitted to at least one of an issuer, an acquirer, and/or a merchant advising that the account is closed. The notification may be accompanied by additional information, such as whether the authorization request message is likely due to a data integrity issue or a fraud issue.

In general, the ABU computing device periodically receives account data from one or more issuers and maintains the account data in an ABU account information database. The account data includes expired accounts or changed accounts, for which the account number (e.g., primary account numbers (PAN)) was replaced by a different account number or the account was closed (hereafter expired or changed accounts are collectively referred to as “closed accounts”). The ABU computing device continues to store the old account numbers in the ABU account information database for a predefined period of time. For example, if account A changes to account B, account C changes to account D, and account E changes to account F, account identifiers of accounts A, B, C, D, E, and F are all stored in the ABU account information database. Similarly, if account A changes to account B, account B changes to account C, and account C changes to account D, account identifiers of accounts A, B, C, and D are all stored in the ABU account information database.

If a merchant or other requesting party wishes to verify or update any account data that the requesting party stores in its own database, the requesting party may submit update requests to the ABU computing device. For example, in the case of recurring CNP transactions, a merchant may submit an update request to the ABU computing device for account information associated with accounts that may be later submitted for authorization (as part of the recurring payment transaction). The ABU computing device may receive these update requests from requesting parties, such as one or more merchants and/or acquirer banks. The ABU computing device provides the requested data in an update response. In some embodiments, the ABU computing device receives receipt notifications indicating that the requesting party updated its corresponding account information database, the update response message being configured to cause the requesting parties' computing devices to transmit the receipt notifications to the ABU computing device as a return message.

In response to receiving an update request, the ABU computing device will perform a look up or will otherwise retrieve account data from the ABU account information database. In certain embodiments, account data stored in the ABU account information database may be stored based on account identifiers and update requests may include one or more account identifiers for which the requesting party is requesting updated account data. In response to an update request, the ABU computing device may generate an update response containing the retrieved account data. In certain embodiments, the update response may also include computer implementable instructions for causing a client device corresponding to the requesting party to update a corresponding database and send a receipt notification back to the ABU computing device. Once generated, the ABU computing device may transmit the update response to the requesting party.

When the requesting party receives the update request, the requesting party (via a requesting party computing device) or the requesting party computing device may execute the included computer-executable instructions, causing the requesting party computing device to update its account-on-file data, generate a receipt notification, and transmit the receipt notification to the ABU computing device. The receipt notification may, among other things, indicate whether the requesting party successfully updated its account-on-file data.

In the example embodiment, a payment transaction including a CNP recurring payment transaction may be initiated by a merchant or an acquirer. An authorization request message associated with the payment transaction is transmitted by the merchant/acquirer to a payment processor and then on to the issuing bank for approval or denial. Before the authorization request messages proceed onto the issuing bank for authorization, the ABU computing device receives the authorization request message from the payment processor and reviews each incoming transaction. The ABU computing device compares each transaction to account data in an ABU account information database to make sure that the account is not closed. More specifically, the ABU computing device compares an account number (e.g., a PAN) included in an authorization request message to account numbers associated with closed accounts listed in the ABU account information database. In one embodiment, the comparison occurs in real time upon receipt of an authorization request message, which enables the ABU computing device to take real-time action, such as, for example, initiating a block on a transaction authorization. In another embodiment, the comparison occurs post-authorization. In such an embodiment, a predefined periodic process (e.g., a daily process) compares account numbers included in authorization request messages to account numbers associated with closed accounts listed in the ABU account information database, and creates a file that is transmitted to the issuers. The file includes, among other things, data on closed accounts that were used in successful or attempted transaction authorizations. The authorization system is not impacted by this embodiment, but further steps are then taken to address the successful or attempted fraudulent transactions.

In one embodiment, the ABU computing device monitors authorization activity on closed accounts and notifies relevant parties (i.e., an issuer, an acquirer, and/or a merchant) of potential fraudulent activity after a predefined number of authorization request messages are received using account data of a closed account. Authorization request messages can result in declined or successful transactions. The ABU computing device captures authorization information, alerts one or more relevant parties, and transmits the information to the relevant party to notify the relevant party of potential fraudulent activity. For example, in the event that account A is replaced by account B, the ABU computing device monitors authorization activity associated with account A. If the ABU computing device identifies that account A is identified in one or more authorization request messages, the ABU computing device notifies relevant parties of a potential fraud concern on account A. In some embodiments, the ABU computing device only notifies the relevant parties after predefined conditions are met, such as, but not limited to, (i) after a predefined number of authorization request messages occur, (ii) after a predefined number of authorization request messages occur within a predefined time period, and/or (iii) after a predefined number of authorization request messages are received, wherein each authorization request message is associated with a transaction over a predefined transaction amount.

In another embodiment, the ABU computing device monitors authorization activity on closed accounts and automatically declines authorization request messages on behalf of the issuer. In certain embodiments, the ABU computing device only declines an authorization request message if predefined conditions or rules are met. These predefined conditions or rules are stored in an ABU database or memory. In one embodiment, the ABU computing device only declines an authorization request message if a transaction associated with the authorization request message is under a predefined amount. In an alternative embodiment, if the transaction is over a predefined amount, the ABU computing device transmits a fraud alert or fraud notification to the issuer, whereupon the issuer may take action.

The ABU computing device is further configured to perform data integrity monitoring of reportedly closed accounts associated with authorization request messages that have been authorized by an issuer. For example, occasionally issuers submit records to the ABU computing device identifying closed accounts when the identified closed accounts are not actually closed, resulting in accounts marked as closed receiving authorization approvals. Upon identifying a data integrity issue, the ABU computing device transmits a notification to the issuer that one or more accounts listed as closed may actually be open due to regular approval authorizations on the one or more accounts.

In one embodiment, after receiving one or more authorization request messages on a closed account, the ABU computing device is configured to analyze account data associated with the closed account to determine whether the one or more authorization request messages are likely due to a data integrity issue or a fraud issue. For example, if there are continuous transaction approvals on a reportedly closed account at several different merchants, the ABU computing device may determine that it is likely due to a data integrity issue (i.e., the account is not actually closed).

In one embodiment, the ABU computing device generates enhanced transaction-related messages to the relevant parties. The ABU computing device receives an authorization request message, which is transmitted to the issuer for approval. At the same time, the ABU computing device transmits another message to the relevant parties related to that transaction with further detail about the transaction. For example, if the ABU computing device determines that an authorization request message is likely related to fraud, the ABU computing device may generate and transmit a separate message over the network to notify the relevant parties who may take any necessary remedial actions. In another embodiment, the ABU computing device enhances the authorization request message by adding additional data about the potentially fraudulent transaction.

The systems and methods described herein provide the technical advantages of (a) reducing the likelihood that fraudulent payment card transactions will be approved, thereby improving network bandwidth and reducing time and resources required to correct such transactions; (b) identifying and correcting erroneous account data and erroneously closed accounts being used for payment card transactions, similarly reducing resources required to correct such transactions; (c) preventing fraudulent transactions using old account numbers; (d) monitoring transactions for potential fraud and data integrity issues for cardholders, issuers, merchants, and acquirers; and (e) monitoring for potential fraud on no longer valid accounts as well as closed accounts and notify issuers ahead of time to ensure the proper tools are in place to mitigate the fraud, thereby improving network bandwidth and reducing time and resources required to correct such fraudulent transactions.

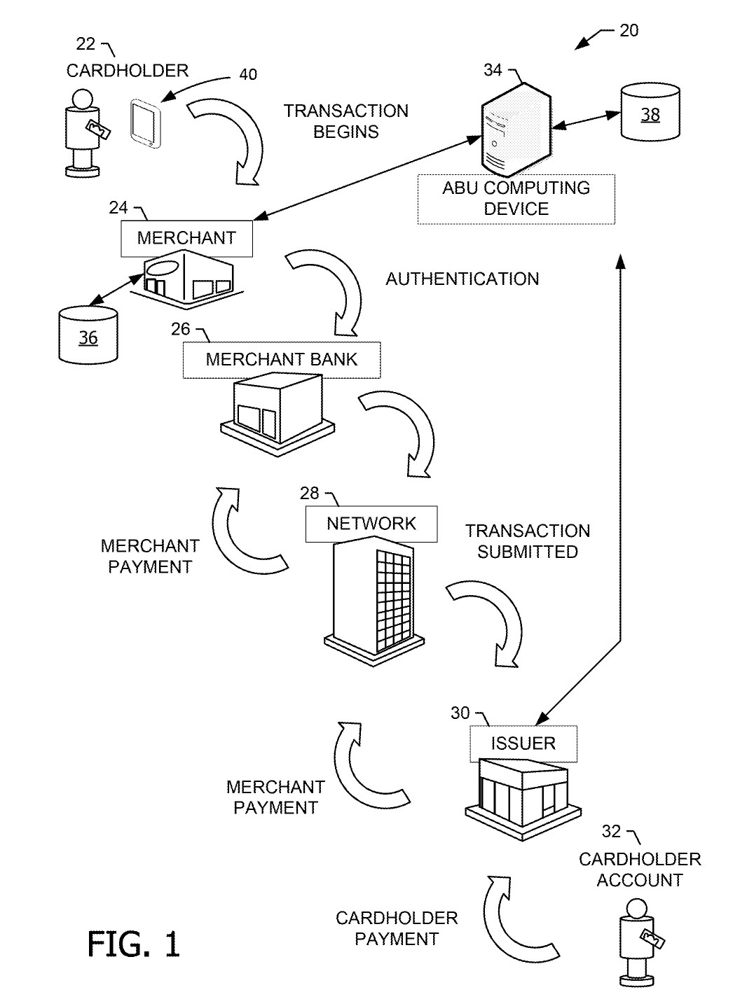

FIG. 1 is a schematic diagram illustrating a payment platform 20 that includes an enhanced ABU computing device 34. Embodiments described herein may relate to a transaction card system, such as a payment card payment system using the MasterCard® interchange network. The MasterCard® interchange network is a set of proprietary communications standards promulgated by MasterCard International Incorporated for the exchange of financial transaction data and the settlement of funds between financial institutions that are associated with MasterCard International Incorporated. (MasterCard is a registered trademark of MasterCard International Incorporated located in Purchase, N.Y.).

In payment platform 20, a financial institution referred to as the “issuer” or “issuing bank” 30 issues a transaction card, such as a credit card, debit card, and the like, to an accountholder 22, also referred to herein as a consumer or cardholder, who uses the transaction card to tender payment for a purchase from merchant 24. To accept payment with the transaction card, merchant 24 normally establishes an account with a financial institution that is part of the financial payment system. This financial institution is referred to as the “merchant bank,” the “acquiring bank,” or the “acquirer” 26. In one embodiment, accountholder 22 tenders payment for a purchase using a transaction card at a transaction processing device 40 (e.g., a point of sale device or merchant website), and merchant 24 then requests authorization from a merchant bank 26 for the amount of the purchase. The request is usually performed through the use of a point-of-sale terminal, which reads account information from a magnetic stripe, a chip, embossed characters, and the like, included on the transaction card of the accountholder 22 and communicates electronically with the transaction processing computers of merchant bank 26. In the context of transactions with online merchants, an accountholder 22 may provide their account information, such as their account number, a card verification number, an expiration date, and the like through a website. Alternatively, merchant bank 26 may authorize a third party to perform transaction processing on its behalf. In this case, the point-of-sale terminal may be configured to communicate with the third party. Such a third party may be referred to as a “merchant processor,” an “acquiring processor,” or a “third party processor.”

Using an interchange network 28, computers of merchant bank 26 may communicate with computers of an issuer bank 30 to determine whether account 32 of accountholder 22 is in good standing and whether the purchase is covered by an available credit line of the account 32 corresponding to accountholder 22. During a course of a transactions, transaction-related messages containing transaction data may be generated and transmitted between parties in payment platform 20. For example, transactions generally involve an authorization step in which transaction data is sent as an authorization request message from merchant 24 to issuer 30 over payment network 28. Payment network 28 includes a payment processor. Based on data contained in the authorization request message, issuer 30 determines whether to approve or decline the transaction, for example, by determining if accountholder 22 has sufficient funds and/or if the account information submitted in the authorization request message is correct. Issuer 30 then transmits an authorization response to merchant 24 indicating whether the transaction is approved or declined.

Merchants, such as merchant 24 may store payment card account information corresponding to one or more cardholders in a merchant account information database 36. In certain embodiments, the merchant account information database 36 may be a local or remote database accessible by merchant 24. During a transaction, merchant 24 may retrieve account information from the merchant account information database 36 as opposed to acquiring the information from accountholder 22, such as by having accountholder 22 provide his or her payment card account information by swiping a payment card or manually entering payment card information into a merchant website. So called “account-on-file” transactions may include recurring payments such as subscription fees, membership fees, electronic bills, and the like. Account-on-file transactions may also include instances when accountholder 22 is a repeat customer of merchant 24. Accordingly, account-on-file transactions generally require a cardholder to provide his or her payment card account information initially and then to authorize or enroll in an account-on-file service. Once enrolled, subsequent payments by accountholder 22 may be streamlined by either automatically charging accountholder 22 or by automatically retrieving account information corresponding to accountholder 22 from merchant account information database 36.

For example, merchant 24 may be an internet service provider (ISP) that provides internet connectivity to accountholder 22 in exchange for a monthly service fee. Accountholder 22 may enroll in an automatic bill pay service with the ISP to pay for the monthly service charge. The ISP may store accountholder 22's account data in merchant account information database 36. When the monthly service charge is due, the ISP may retrieve the account data from merchant account information database 36 and may submit a transaction based on the retrieved account data to issuer 30. As another example, merchant 24 may be an online merchant from which accountholder 22 makes regular purchases. Accountholder 22 may create a user profile with the online merchant and provide his or her payment card account information, which the online merchant may then store in account information database 36. When accountholder 22 later logs onto the online merchant's website and selects goods or services for purchase, the online merchant may retrieve accountholder 22's payment card account data and facilitate accountholder 22's purchase by automatically populating purchase forms or performing similar steps with the retrieved account data.

Although account-on-file transactions provide improved efficiency for both merchants and cardholders, payment card account information is subject to change. For example, a payment card's expiration date may lapse or an issuing bank may reissue a payment card with a different primary account number (PAN). If merchant 24 attempts to submit a transaction to issuer 30 after such a change and uses out-of-date account information, issuer 30 is likely to reject the transaction. These rejected transactions oftentimes result in the payment transaction being re-submitted, which results in numerous computer messages being sent over the network that could be avoided with the present system. Thus, the payment system addresses these problems and results in improved bandwidth over the network, increased data storage (not having to store unnecessary message data), improved data integrity, and a more efficient overall network.

In the example embodiment, ABU account information database 38 stores payment card account information for one or more cardholders, such as accountholder 22. For each payment card account of a cardholder, ABU account information database 38 includes current account information including, but not limited to, a current account identifier and a current expiration date. ABU account information database 38 also stores outdated account information that is linked within database 38 to corresponding current account information. In addition, ABU computing device 34 periodically receives payment card account information updates from one or more issuers, such as issuer 30, and stores the received payment card account information in an ABU account information database 38.

ABU computing device 34 is further configured to receive authorization request messages transmitted from the merchant and/or the acquirer. These authorization request messages are received by ABU computing device 34 from the payment processor at network 28. In other words, as the authorization request messages are sent over the network for processing, ABU computing device 34 also processes these messages. Each authorization request message is associated with an account and a PAN. ABU computing device 34 reviews each authorization request message and compares an included PAN to payment card account information in ABU account information database 38 to determine whether an account is closed or to determine an up-to-date account identifier.

In certain embodiments, in response to receiving a transaction-related message for a closed account, ABU computing device 34 extracts data from the transaction-related message. ABU computing device 34 generates and transmits a notification message (e.g., an alert) including the extracted data to issuer 30. The notification message may be used to indicate at least one of: (i) potential fraudulent activity; (ii) an inconsistency between an account identifier contained in the transaction-related message and a corresponding current account identifier stored in the ABU account information database; and (iii) whether the authorizations are due to a data integrity issue or a fraud issue.

In alternative embodiments, the ABU computing device 34 generates enhanced transaction-related messages by supplementing the transaction-related messages with additional data or modifying existing data contained in the transaction-related messages. For example, if ABU computing device 34 receives an authorization request message to be sent to issuer 30 from merchant 24, ABU computing device 34 is configured to generate a report including data regarding merchant 24 and accountholder 22, information on an account associated with the authorization request message, and/or data integrity issues or fraud issues. ABU computing device 34 is further configured to enhance the authorization request message (e.g., embed additional data into an ISO 8583 network message) to include the report before transmitting the enhanced authorization request message to issuer 30. Similar to the previously discussed notification messages, enhanced transaction-related messages may be used to indicate at least one of: (i) potential fraudulent activity; (ii) an inconsistency between an account identifier contained in the transaction-related message and a corresponding current account identifier stored in the ABU account information database; and (iii) whether the authorizations are probably due to a data integrity issue or a fraud issue.

In such cases, ABU computing device 34 may also transmit a notification (e.g., an alert) to merchant 24 and/or merchant bank 26 indicating potential fraudulent activity or a data integrity issue. Alternatively, the ABU computing device 34 may enhance the corresponding authorization response message sent by issuer 30 to indicate potential fraudulent activity or a data integrity issue. Identification of whether authorizations associated with closed accounts are likely due to a data integrity issue or a fraud issue may be performed in various ways. For example, ABU computing device 34 is configured to determine whether inconsistent data is likely due to fraud or a data integrity issue based upon one or more authorization request messages. Such information may include, but is not limited to, the date/time of the transaction, the amount of the transaction, the goods or services being purchased, and the like.

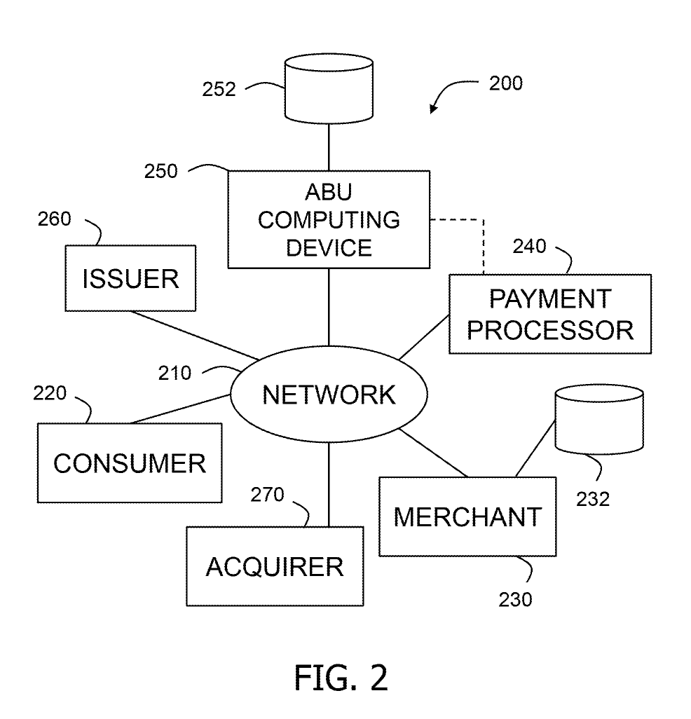

FIG. 2 is a diagram illustrating an automatic billing updater (ABU) manager system 200 including a consumer 220, a merchant 230, a payment processor 240, an issuer 260, an acquirer 270, and an ABU computing device 250, which may correspond to ABU computing device 34 (shown in FIG. 1), in accordance with an example embodiment of the present disclosure.

Referring to FIG. 2, ABU manager system 200 includes computing devices associated with consumer 220, merchant 230, payment processor 240, ABU computing device 250, issuing bank (“issuer”) 260, and acquirer 270, which are connected to each other via network 210. Network 210 may include the Internet, the interchange network 28 of FIG. 1, and/or one or more other networks. For example, a connection between the computing devices may include a wireless network, a wired network, a telephone network, a cable network, a combination thereof, and the like. Examples of suitable connections include, but are not limited to, WiFi, WiMAX, WiBro, local area network, personal area network, metropolitan area network, cellular, Bluetooth, and the like.

Consumer 220 may be a computing device, for example, a mobile phone, a smart phone, a telephone, a computer, a laptop, a desktop, a tablet, an MP3 player, a digital assistant, a server, and the like. Consumer 220 may communicate with merchant 230 in various ways including accessing a website that corresponds to or that is hosted by merchant 230, contacting a phone number of merchant 230, and the like. Payment processor 240 may be a processing entity such as MASTERCARD®, VISA®, AMERICAN EXPRESS®, and the like. Issuer 260 may be a third-party bank that issued a payment card to a cardholder for processing payment transactions through payment processor 240.

Merchant 230 corresponds to a computing device configured to accept and process payment card transactions and to maintain a merchant account information database, such as a database 232 (similar to database 36 in FIG. 1), that includes payment card account information associated with one or more cardholders. Merchant account information database 232 may be incorporated into merchant 230 or may be otherwise accessible by merchant 230 via a network, such as network 210. The information maintained in merchant account information database 232 may generally be used to facilitate account-on-file transactions, such as automatic recurring payments.

ABU computing device 250 is generally configured to receive account data from an issuing party, such as issuer 260, to store the account data, to provide the account data to a requesting party, such as merchant 230, and to monitor for fraudulent activity and data integrity issues. ABU computing device 250 may include or have access to one or more databases. For example, in the embodiment of FIG. 2, ABU computing device 250 has access to an ABU account information database 252 (similar to database 38 in FIG. 1). ABU account information database 252 may be stored in an internal storage device of ABU computing device 250 or may be remote to ABU computing device 250 but otherwise accessible by ABU computing device 250. Each of ABU account information database 252 may be stored on one or more data storage devices in one or more databases, tables, or similar storage structures.

ABU account information database 252 contains account data received from one or more issuing parties, such as issuer 260. ABU account information database 252 may be updated by ABU computing device 250 in response to receiving account data from issuer 260 over network 210. In certain embodiments, the account data may be sent by issuer 260 according to a predetermined schedule (e.g., daily, bi-weekly, etc.). In other embodiments, ABU computing device 250 may transmit a call to issuer 260 and account data may be sent by issuer 260 to ABU computing device 250 in response to the call. In still other embodiments, issuer 260 may automatically send account data to ABU computing device 250 upon changes to account data associated with one or more cardholders.

ABU computing device 250 generally sends account data to requesting parties, such as merchant 230, upon receiving an update request. Update requests may be received over network 210 directly from merchant 230 or may be batched together by acquirer 270 or merchant bank 26 of FIG. 1, and transmitted to ABU computing device 250 in a batched format. Update requests generally include one or more account identifiers corresponding to payment card accounts for which the requesting party is requesting account data. In response to receiving an update request, ABU computing device 250 retrieves the account data corresponding to the one or more account identifiers, generates an update response including the account data, and sends the update response to the requesting party. In certain embodiments, update responses may also include computer executable instructions, such as a script, configured to cause the requesting party to update an account information database of the requesting party, to generate a receipt notification indicating whether the update was a successful, and to transmit the receipt notification to ABU computing device 250.

ABU computing device 250 may also be configured to receive messages transmitted over network 210 during a payment card transaction. For example, in certain embodiments, ABU computing device 250 may receive authorization messages such as authorization request messages sent from merchant 230 to issuer 260 and/or authorization response messages sent from issuer 260 to merchant 230 via payment processor 240 and network 210. In response to receiving a transaction-related message, ABU computing device 250 reviews each transaction coming through and compares an account number associated with the transaction to the account data in ABU account information database 252 to determine whether the account is not closed. The comparison may occur in real time or post-authorization, as described above.

In one embodiment, ABU computing device 250 monitors authorization request messages made on closed accounts, and declines the authorization requests on behalf of the issuer. In certain embodiments, the ABU computing device only declines authorization requests under predefined conditions, as described above.

In another embodiment, ABU computing device 250 generates and transmits a fraud alert or fraud notification to merchant 230, issuer 260, and/or acquirer 270. In another embodiment, ABU computing device 250 enhances a transaction-related message by supplementing or modifying the data stored in the payment message. ABU computing device 250 may then transmit the notification message or enhanced transaction-related message, as required. In one embodiment, ABU computing device 250 monitors authorization activity and notifies the issuer of potential fraudulent activity after a predefined number of authorization requests occur on a closed account. ABU computing device 250 captures authorization information and transmits the information to merchant 230, issuer 260, and/or acquirer 270 to notify one or more of these parties of potential fraudulent activity. In additional embodiments, ABU computing device 250 performs a data integrity check, transmitting a notification to issuer 260 that one or more accounts listed as closed may actually be open.

In one embodiment, ABU computing device 250 may be further configured to generate and transmit reports of potential fraudulent activity or data integrity issues to merchant 230, issuer 260, and/or acquirer 270. For example, ABU computing device 250 may generate a report that identifies potential fraudulent activity where authorization request message where submitted on old account numbers.

In other embodiments, reports and/or notifications may be generated as messages that conform to one or more standards. Such standards may include, but are not limited to ISO 8583 and ISO 20022, which generally provide specifications for the format and content of messages related to electronic transactions made by cardholders using payment cards and message transmitted between financial institutions, respectively. In certain embodiments, reports and/or notifications generated by the ABU computing device may be created as a document in a markup language, such as extensible markup language (XML). In still other embodiments, reports and/or notifications may be generated in a format compatible with and inserted into other messages transmitted over network 210. For example, ABU computing device 250 may generate a report suitable for insertion into an authentication request or response message sent between a merchant and an issuer over network 210.

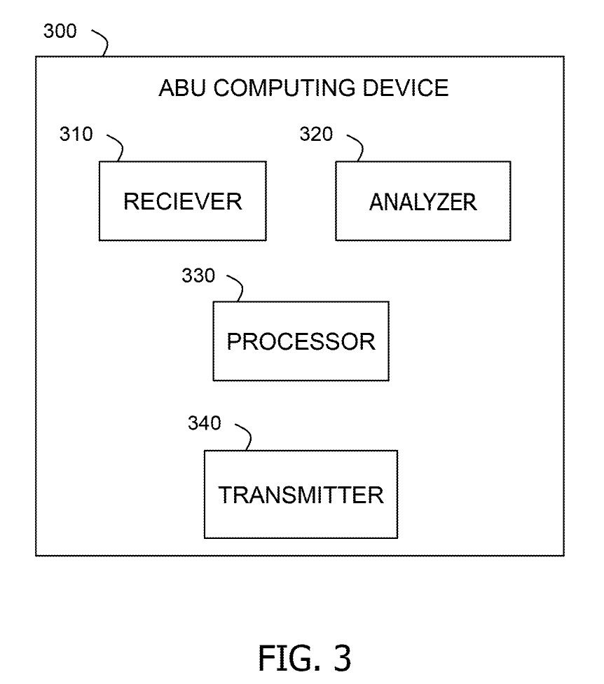

FIG. 3 is a diagram illustrating an example embodiment of an ABU computing device that may be included in the ABU manager system of FIG. 2, in accordance with an example embodiment of the present disclosure.

Referring to FIG. 3, ABU computing device 300 may correspond to ABU computing device 250 shown in FIG. 2. ABU computing device 300 may be coupled to payment processor 240 or may be a separate computing device included in the system of FIG. 2, and may be connected to one or more of the other computing devices via the network 210. In this example, ABU computing device 300 includes a receiver 310, an analyzer 320, a processor 330, and a transmitter 340. ABU computing device 300 may include additional components not shown, or less than the amount of components shown. Also, one or more of the components in this example may be combined or may be replaced by processor 330. The computer components described herein (e.g., receiver 310; analyzer 320; processor 330; and transmitter 340) may include hardware and/or software elements that are specially configured or programmed to perform the steps described herein.

Receiver 310 is generally configured to receive account data from one or more issuers, such as issuer 260 of FIG. 2. Such account data may include, but is not limited to, payment card account numbers, payment card account expiration dates, and the like. Receiver 310 may also be configured to receive account data from various databases. For example, receiver 310 may receive account data from ABU account information database 252, as depicted in FIG. 2. Receiver 310 may also be configured to receive update requests for account data stored in account information database 252 from one or more parties, such as a merchant or acquiring bank, and corresponding receipt notifications transmitted by such parties in response to receiving the requested account data. In certain embodiments, receiver 310 may also be configured to receive messages sent over an interchange network, such as network 210 of FIG. 2, which may include, but are not limited to, authorization request messages and authorization response messages. Messages and account data received by receiver 310 may be in a batch format that aggregates multiple messages or data corresponding to multiple accounts. Accordingly, receiver 310 may be configured to parse individual messages and account data entries from such batched formats.

Analyzer 320 analyzes data and messages received through receiver 310. Analyzer 320 generally determines whether the authorizations are probably due to a data integrity issue or a fraud issue. For example, analyzer 320 may compare the received data or message with historical data to determine whether authorizations are probably due to a data integrity issue or a fraud issue, such as the last time a transaction was submitted by each merchant, whether the transaction was authorized by an issuing bank, and the like. In certain embodiments, analyzer 320 may determine whether data or messages received by receiver 310 include flags or other data that identify the type of data or message received by receiver 310. For example, the data may identify the message as one of an update request, a report request, or a transaction-related message such as an authorization request or authorization response message.

In response to receiving updated account data from an issuing party, processor 330 may generally update an ABU account information database, such as ABU account information database 252 of FIG. 2. For example, processor 330 may determine whether the updated account data received from the issuing party includes account data corresponding to an account for which data is maintained in the ABU account information database. Processor 330 may also compare any existing account data in the ABU account information database with that of the updated account data to determine if any changes have occurred. Processor 330 may also add new entries to ABU account information database for any data corresponding to new accounts or overwrite any outdated account data contained in the ABU account information database.

When updating existing records in the ABU account information database, processor 330 may also populate data fields or create records for the account data being overwritten. Such fields or records may be cross-referenced or otherwise linked to the corresponding updated account data received from the issuing party. Doing so permits ABU computing device 300 to identify current account data corresponding to outdated account data that may be submitted by a merchant, an acquiring bank, and the like.

In response to receiving an update request from a requesting party, processor 330 may retrieve the requested account data. More specifically, processor 330 may determine what account data is being requested, generate a request or query for retrieving the requested account data from the ABU account information database, submit the request to ABU account information database, and, after receiving the requested account data, generate an update response containing the requested data for transmission to the requesting party by transmitter 340. In certain embodiments, processor 330 may also include machine executable code in update response messages that cause the requesting party to update an account information database of the requesting party and to generate and transmit a receipt notification indicating whether the update was successfully completed by the requesting party.

In certain embodiments, processor 330 may be configured to analyze the contents of the ABU account information database and the ABU traffic database, to generate corresponding notification messages based on the results of such analyses, and to transmit the notification messages to relevant parties. For example, processor 330 monitors authorization activity and generates a notification message of potential fraudulent activity after a predefined number of authorizations are attempted on a closed account. The notification message may then be sent to the merchant, the acquiring bank, the issuing bank, and the like to notify the parties of fraudulent activity.

In one embodiment, processor 330 may also be configured to monitor authorization request messages made on closed accounts and block the authorization on behalf of the issuer. In certain embodiments, processor 330 only blocks the transaction if it is under a predefined amount. In other embodiments, processor 330 transmits a fraud alert or fraud notification to the issuer if the transaction is over a predefined amount, whereupon the issuer may take action.

Processor 330 may also generate reports containing or based on potential fraudulent activity or data integrity issues. Generation and transmission of a report may be according to a request received by ABU computing device 300, a predetermined schedule, or as the result of a predefined event, such as receiving a transaction authorization request on a closed account.

In certain embodiments, ABU computing device 300 also includes a transmitter 340 for transmitting data, including, but not limited to update response messages; enhanced transaction-related messages; requests/queries for account data from one or more of an ABU account information database; reports based on data contained in one or more of an ABU account information database, an ABU traffic database, and a transaction traffic database; and the like.

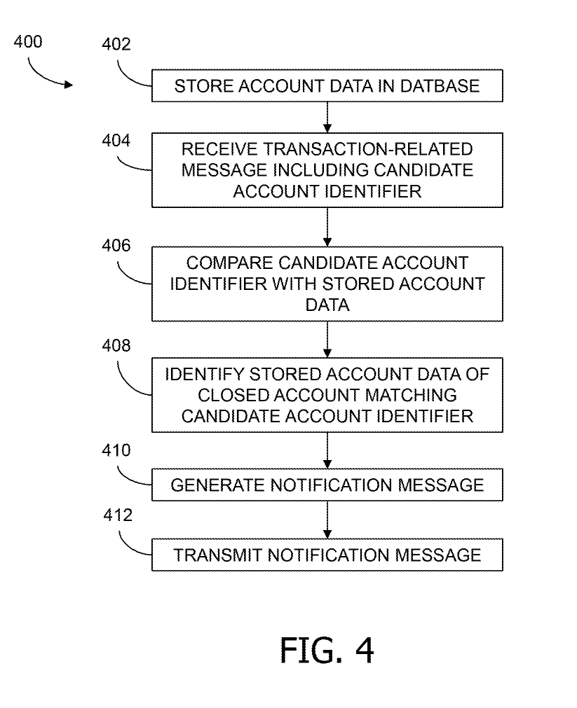

FIG. 4 is a diagram illustrating an example of a method 400 for monitoring fraudulent activity and data integrity issues associated with closed accounts that may be performed by an ABU computing device, such as ABU computing device 300 of FIG. 3.

The ABU computing device stores 402 account data in an ABU account information database. The account data includes closed accounts (i.e., expired or changed accounts) where the accounts numbers were replaced by different account numbers or closed. The account data may further include an account identifier for each payment card account having associated data stores in the ABU account information database. Such current account data may include, but is not limited to, a payment card account number, a payment card expiration date, a security code, and the like.

Authorization request messages are transmitted from the merchant/acquirer to the ABU computing device. During the course of a payment card transaction, the ABU computing device receives 404 a transaction-related message associated with a closed account. The transaction-related message may include an authorization request message, or other messages containing transaction data that may be transmitted over a network, such as network 210. In the example embodiment, the ABU computing device receives 404 an authorization request message including a candidate account identifier, the authorization request message requesting authorization of a transaction.

The ABU computing device identifies potential fraudulent activity or potential data integrity issues associated with the transaction-related message. More specifically, the ABU computing device compares 406 an account number included in the transaction-related message (the candidate account identifier) to account numbers associated with closed accounts listed in the ABU account information database. After receiving one or more authorization request messages on a closed account, the ABU computing device is configured to analyze account data associated with the closed account to determine whether the one or more authorization request messages are likely due to a data integrity issue or a fraud issue. The ABU computing device further identifies 408 an account identifier associated with a closed account stored in the ABU account information database matching the candidate account identifier.

The ABU computing device generates 410 a report or notification message to a merchant, an issuer, and/or an acquirer. In certain embodiments, the notification may operate as an alert that simply notifies the merchant, the issuer, and/or the acquirer of potential fraudulent activity or data integrity issues. In other embodiments, the notification may include some or all of the current and old account information. Once generated, the ABU computing device transmits 412 the report or the notification to the merchant, the issuer, and/or the acquirer. In some embodiments, the ABU computing device declines the authorization request message for the issuer instead of or in addition to transmitting the report or the notification.

Computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, the terms “card,” “transaction card,” “financial transaction card,” and “payment card” refer to any suitable transaction card, such as a credit card, a debit card, a prepaid card, a charge card, a membership card, a promotional card, a frequent flyer card, an identification card, a gift card, and/or any other device that may hold payment account information, such as mobile phones, Smartphones, personal digital assistants (PDAs), key fobs, and/or computers. Each type of transaction card can be used as a method of payment for performing a transaction. In addition, consumer card account behavior can include, but is not limited to, purchases, management activities (e.g., balance checking), bill payments, achievement of targets (meeting account balance goals, paying bills on time), and/or product registrations (e.g., mobile application downloads).

For example, one or more computer-readable storage media may include computer-executable instructions embodied thereon for maintaining account-on-file information. In this example, the computing device may include a memory device and a processor in communication with the memory device, and when executed by said processor, the computer-executable instructions may cause the processor to perform a method, such as the method described and illustrated in the example of FIG. 4.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable medium. In an example, the system is executed on a single computer system, without a connection to a server computer. In a further example, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional examples that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to describe the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An automatic billing updater (ABU) computing device for detecting data inconsistencies thereby reducing fraudulent transactions or identifying data integrity issues, the ABU computing device comprising one or more processors in communication with one or more memory devices, the ABU computing device configured to:
store account data in an ABU account information database including a plurality of account identifiers of closed accounts;
receive an authorization request message including a candidate account identifier, the authorization request message requesting authorization of a transaction;
compare the candidate account identifier with the plurality of account identifiers associated with closed accounts stored in the ABU account information database;
identify an account identifier associated with a closed account stored in the ABU account information database matching the candidate account identifier;
generate a notification message indicating that the candidate account is closed; and
transmit the notification message to at least one party associated with the authorization request message.

2. An ABU computing device in accordance with claim 1, wherein the ABU computing device is further configured to generate the notification message after at least one of (i) a predefined number of authorization request messages are received that include the candidate account identifier that matches one of the closed account identifiers, (ii) a predefined number of authorization request messages that include the candidate account identifier are received within a predefined time period, and (iii) a predefined number of authorization request messages that include the candidate account identifier are received and each of the predefined number of authorization request messages include a transaction amount over a predefined transaction amount.

3. An ABU computing device in accordance with claim 1, wherein the ABU computing device is further configured to automatically decline the authorization request message on behalf of an issuer after determining that the candidate account identifier matches one of the closed account identifiers, wherein a decline message is transmitted to the merchant as an ISO 8583 network message.

4. An ABU computing device in accordance with claim 1, wherein the ABU computing device is further configured to analyze account data associated with the candidate account identifier to determine whether the authorization request message is associated with a data integrity issue or a fraudulent transaction.

5. An ABU computing device in accordance with claim 4, wherein the ABU computing device is further configured to generate the notification message including an indication of whether the authorization request message is associated with a data integrity issue or a fraudulent transaction

6. An ABU computing device in accordance with claim 1, wherein the ABU computing device is further configured to generate the notification message by appending the authorization request message with data contained in the ABU account information database.

7. An ABU computing device in accordance with claim 1, wherein the party includes at least one of an issuer, an acquirer, and a merchant.

8. A computer-implemented method for detecting data inconsistencies thereby reducing fraudulent transactions or identifying data integrity issues, the method implemented using an automatic billing updater (ABU) computing device, the method comprising:
storing account data in an ABU account information database including a plurality of account identifiers of closed accounts;
receiving an authorization request message including a candidate account identifier, the authorization request message requesting authorization of a transaction;
comparing the candidate account identifier with the plurality of account identifiers associated with closed accounts stored in the ABU account information database;
identifying an account identifier associated with a closed account stored in the ABU account information database matching the candidate account identifier;
generating a notification message indicating that the candidate account is closed; and
transmitting the notification message to at least one party associated with the authorization request message.

9. The method of claim 8, wherein generating a notification message comprises generating the notification message after at least one of: (i) receiving a predefined number of authorization request messages that include the candidate account identifier that matches one of the closed account identifiers, (ii) receiving a predefined number of authorization request messages that include the candidate account identifier within a predefined time period, and (iii) receiving a predefined number of authorization request messages that include the candidate account identifier, each of the predefined number of authorization request messages including a transaction amount over a predefined transaction amount.

10. The method of claim 8 further comprising:
determining that the candidate account identifier matches one of the closed account identifiers; and
automatically declining the authorization request message on behalf of an issuer after said determining.

11. The method of claim 10, wherein automatically declining the authorization request message comprises transmitting a decline message to the merchant as an ISO 8583 network message.

12. The method of claim 8 further comprising analyzing account data associated with the candidate account identifier to determine whether the authorization request message is associated with a data integrity issue or a fraudulent transaction.

13. The method of claim 12, wherein generating a notification message comprises generating the notification message including an indication of whether the authorization request message is associated with a data integrity issue or a fraudulent transaction.

14. The method of claim 8, wherein generating a notification message comprises appending the authorization request message with data contained in the ABU account information database.

15. A non-transitory computer-readable storage medium having computer-executable instructions embodied thereon, wherein when executed by an automatic billing updater (ABU) computing device including a processor in communication with a memory, the computer-executable instructions cause the ABU computing device to:
store account data in an ABU account information database including a plurality of account identifiers of closed accounts;
receive an authorization request message including a candidate account identifier, the authorization request message requesting authorization of a transaction;
compare the candidate account identifier with the plurality of account identifiers associated with closed accounts stored in the ABU account information database;
identify an account identifier associated with a closed account stored in the ABU account information database matching the candidate account identifier;
generate a notification message indicating that the candidate account is closed; and
transmit the notification message to at least one party associated with the authorization request message.

16. The non-transitory computer-readable storage medium of claim 15, wherein the computer-executable instructions further cause the ABU computing device to generate the notification message after at least one of (i) a predefined number of authorization request messages are received that include the candidate account identifier that matches one of the closed account identifiers, (ii) a predefined number of authorization request messages that include the candidate account identifier are received within a predefined time period, and (iii) a predefined number of authorization request messages that include the candidate account identifier are received and each of the predefined number of authorization request messages include a transaction amount over a predefined transaction amount.

17. The non-transitory computer-readable storage medium of claim 15, wherein the computer-executable instructions further cause the ABU computing device to automatically decline the authorization request message on behalf of an issuer after determining that the candidate account identifier matches one of the closed account identifiers, wherein a decline message is transmitted to the merchant as an ISO 8583 network message.

18. The non-transitory computer-readable storage medium of claim 15, wherein the computer-executable instructions further cause the ABU computing device to analyze account data associated with the candidate account identifier to determine whether the authorization request message is associated with a data integrity issue or a fraudulent transaction.

19. The non-transitory computer-readable storage medium of claim 18, wherein the computer-executable instructions further cause the ABU computing device to generate the notification message including an indication of whether the authorization request message is associated with a data integrity issue or a fraudulent transaction.

20. The non-transitory computer-readable storage medium of claim 15, wherein the computer-executable instructions further cause the ABU computing device to generate the notification message by appending the authorization request message with data contained in the ABU account information database.
